(19) United States
(12) Patent Application Publication
(10) Pub. No.: US 2014/0246289 A1
(43) Pub. Date: Sep. 4, 2014

(54) CONVEYOR AND METHOD TO CONVEY ANIMAL PRODUCTS IN AN AGRICULTURAL BUSINESS

(71) Applicant: BIG DUTCHMAN INTERNATIONAL GMBH, Vechta (DE)

(72) Inventor: LARS HALBRITTER, Lohne (DE)

(73) Assignee: BIG DUTCHMAN INTERNATIONAL GMBH, Vechta (DE)

(21) Appl. No.: 14/192,987

(22) Filed: Feb. 28, 2014

(30) Foreign Application Priority Data
Mar. 1, 2013 (DE) 20 2013 001 935.2

(51) Int. Cl. B65G 43/02

(52) U.S. Cl. CPC B65G 43/02
USPC 198/502.1

(57) ABSTRACT

The invention relates to a conveyor to convey animal products in an agricultural business, as well as a drive unit for such a conveyor. Furthermore, the invention relates to a method to convey animal products in an agricultural business by means of a conveyor. The conveyor comprises a conveyor belt, a belt drive for driving the conveyor belt in a minimum of one conveying direction, and a measuring unit that is designed and arranged to determine a load rate of the conveyor belt, wherein the load rate of the conveyor belt is a power value of the belt drive and/or a bearing reaction of a bearing in the belt drive.

### CROSS-REFERENCE TO FOREIGN PRIORITY APPLICATION

The present application claims the benefit under 35 U.S.C. §119(b) of German Application No. 20 2013 001 935.2, filed Mar. 1, 2013, entitled “Conveyor and Method to Convey Animal Products in an Agricultural Business.”

### FIELD OF THE INVENTION

The invention relates to a conveyor and method to convey animal products in an agricultural business as well as a drive unit for such a conveyor.

Furthermore, the invention relates to a method to convey animal products in an agricultural business by means of a conveyor.

Animal products are produced in agricultural business, in particular stables. In modern, high-technologies stables, the environmental conditions of the animals are optimized to make a species-appropriate and simultaneously efficient production possible. In this regard, animal products shall mean in particular products from poultry farming, such as eggs or meat, and whole animals, such as broiler chickens. However, by-products from this production, such as animal feces, which are generated in breeding, egg production or meat production, such as the fattening of broilers, are understood as animal products.

Conveyors to convey animal products, mostly with an endless belt and a belt drive, which drives the conveyor belt in at least one conveying direction, are a component of modern stables. Such control units serve in particular to quickly and reliably evacuate and move animal products from different livestock systems (small group, aviary, cage, etc.). Such livestock and conveying systems are usually carried out over the course of several days, while the levels can be arranged vertically above each other, but also laterally offset above each other in stables.

In the case of conveyors to convey feces, it can additionally be provided that the feces be aired so as to dry it or to dry it in separate drying systems, in which the initially referenced conveyors can also be used.

Existing conveying systems can exercise maximum traction force on the conveyor belt, depending on the construction embodiment of the belt drives. The mass or the quantity of the animal products on the conveyor belt and the coefficient of friction of the conveyor belt against the supporting substructure, as well as conveyor belt bottom joists and/or conveyor belt lateral supports work against this traction force. With increasing load of the conveyor belt with animal products, an overload of the conveyor belt can occur, with the consequence that the drive power put on the conveyor belt by the belt drive, in particular traction force, is not sufficient to drive the conveyor belt in at least one conveying direction. In this case, the further transport and/or the removal of the animal products with the conveyor belt is no longer possible. At the same time, such an overload of the conveyor belt is not or only reversible with difficulty, since the animal products, such as eggs, feces or broilers have actually landed on the conveyor belt for the purpose of removal and cannot and/or are not supposed to be returned to their original location.

This type of overload can occur when the conveyor is used for the removal of feces, for example, if the intervals of purgation are too long. Generally, purgation is carried out in daily intervals depending on the number of animals in the livestock facility above the conveyor belt and therefore depending on the amount of feces per day and meter. For example, this can be necessary on a daily basis. However, most of the time, a two-day, three-day or n-day purgation is practiced. Here, the whole length of the conveying system is cleaned of feces, for example, or a certain partial length individually, for example, a third of the length of the conveying system. The economical working interest of the farmer is a purgation interval that is as long as possible. The amounts of feces accrued in long purgation intervals, however, can be so large that an unwanted overload of the conveyor belt occurs, with the consequence of a standstill of the conveying system.

From the farmer's view, another reason for a purgation interval that is as long as possible is that in an installed feces ventilation, the feces can be ventilated on the conveyor belt over a longer time period and can therefore be dried. Higher dry substance contents reduce the trans-formation of urea into ammonia, which contributes to the improvement of the stable environment and the reduction of ammonia emissions into the environment. The drying effect reduces the mass of the feces on the conveyor belt, which may facilitate longer purgation intervals. For example, due to interruptions, it can, however, be necessary to clean the feces in shorter intervals, such as after a leakage of the water supply for the animals. In such a case, water can leak onto the conveyor belt and accordingly re-increase the mass of feces. An overload of the conveyor belt is particularly apparent if the conveyor belt stands still, since the belt drive is no longer able to drive the conveyor belt in at least one conveying direction. In such a situation, the feces or other animal products must then be unloaded manually from the conveyor belt.

In another field of application, conveying systems are used to remove entire animals, such as broilers, with the use of the conveyor belt. Here, the bottom of the broiler's stable structure is opened in the way that the animals move to the conveyor belt and are removed. An overload of the conveyor belt can occur in this field of application in particular in the way that the workers in charge of opening the bottoms of the livestock facilities add more animal material per time unit to the conveyor belt than it [the conveyor belt] can move in the same time unit. The overload of the conveyor belt can have the consequence in this case as well that the drive power of the belt drive is not sufficient for driving the conveyor belt and/or slack occurs between the conveyor roller of the belt drive and the conveyor belt and the conveyor belt must be manually unloaded.

It is therefore an objective of the present invention to provide an apparatus and a method to convey animal products in an agricultural business so as to reduce or removes one or several of the referenced disadvantages. It is in particular an objective of the present invention to provide an apparatus and a method for conveying animal products in an agricultural business so as to prevent or reduce the overload of a conveyor.

### SUMMARY OF THE INVENTION

This task is solved according to the invention through a conveyor for conveying animal products in an agricultural business, comprising a belt drive for driving the conveyor belt in a minimum of one conveying direction, a measuring unit that is designed and arranged to determine a load rate of the conveyor belt, wherein the load rate of the conveyor belt is a power value of the belt drive and/or a bearing reaction of a bearing in the belt drive. A power value of the belt drive can be a current consumption and/or torque of the belt drive, in particular.

Here, the overload of the conveyor is understood as the status in which the mass and/or amount of animal products on the conveyor belt is so large that the drive power of the belt drive is no longer sufficient to drive the conveyor belt in at least one direction. Loading the conveyor belt is understood as animal products that are moved to the conveyor belt (for example, moved to the conveyor belt by workers or for example, have fallen onto the conveyor belt by force of gravity) and are located on the conveyor belt for the further transport and/or removal.

Preferably, the conveyor belt is an endless conveyor belt with an upper run, which conveys animal products, and designed with a lower run and has, for example, a belt drive with a drive roll on the out-feed side and a return pulley on the opposite side. Assisted by pressure rolls, the conveyor belt can be pushed onto the drive roll so that a high pressing force and therefore a corresponding friction is generated between the conveyor belt and the drive roll, and the conveyor belt is driven by the rotation of the drive roll in at least one conveying direction. Preferably, the belt drive is designed as a bilaterally supported, powered drive roll. The bearings are preferably arranged in a drive housing and/or at a side or drive frame. Furthermore, scrapers can be provided for on the drive roll, which serves to clean the conveyor belt. Preferably, the conveyor belt can be driven in more than one conveying direction, such as in two conveying directions which oppose one another. The belt drive, in particular a drive roll, can preferably be designed to be able to rotate in respectively different directions. More than one belt drive can be provided for; in particular, a conveyor belt for feces can be designed to have multiple levels with at least one belt drive per level.

An adjustment mechanism can be provided for a position change of a belt drive bearing, such as in the form of an adjustment plate to house a bearing of the belt drive. As described above, this adjustment mechanism is moved, for example, by a correction device in such a way that a position change of the belt drive bearing occurs, which can cause a desired course correction of the conveyor belt.

Among other things, the invention is based on the finding that for the prevention of an overload of the conveyor belt, the knowledge of a load rate of the conveyor belt is necessary. It is therefore intended to equip the conveyor with a measuring unit, with which such a load rate of the conveyor belt can be determined. Here, a load rate of the conveyor belt is understood to be a unit, from which conclusions can be drawn (directly or indirectly) regarding a, preferably current, load of the conveyor belt. The measuring unit determines a value, preferably current at the time, for the rate for the load of the conveyor belt.

The knowledge of a rate for the load of the conveyor belt, in particular the current load of the conveyor belt, is what even makes it possible to interact before the actual case of overload, shown through the standstill of the conveyor belt, and to prevent such overload, if possible. In this way, a standstill of the conveyor—and, hence, a manual unloading of the conveyor belt—can be prevented by initiating further transport and/or removal before an overload is reached.

The load rate of the conveyor belt is a power value of the belt drive, in particular a current consumption and/or a torque of the belt drive and/or a bearing reaction of a bearing in the belt drive.

Preferred examples for possible further rates for the load of a conveyor belt are a stretching deformation of an element of the conveyor; a force impacting on an element of the conveyor, in particular pressure and/or traction; a bearing reaction of a bearing in the belt drive; the weight of animal products located on a section of the conveyor belt; a deviation, in particular in the vertical direction, a bearing of a section of the conveyor belt from an initial position; and/or a conveyor belt progress, in particular, conveyor belt speed.

Preferred examples for a measuring unit for the determination of such a rate are a force sensor, in particular a pressure sensor and/or traction sensor, such as a load cell and/or strain gauge; a torque sensor, such as a strain gauge; a current measuring device; a distance sensor; and/or a conveyor belt progress detector, in particular a speed monitor and/or measuring wheel.

Preferably, measuring runs of the conveyor belt can be carried out outside of the actual operation of the conveyor, in order to carry out calibration of the load rate of the conveyor belt, for example, and/or to determine a respectively present load of the conveyor belt. Such measuring runs are preferably carried out apart from each other and only take a short amount of time, preferably less than 10 seconds, in particular, less than 5 seconds so as not to affect the actual operation of the conveyor belt and/or the conveyor.

An embodiment of the conveyor with a control unit is particularly preferred, which is realized in that the determined load rate of the conveyor belt is compared to a set point value and preferably generates a warning message, when a predetermined deviation from the set point value is exceeded or under-run.

The control unit is preferably connected to the measuring unit by means of signal technology, in particular in order to receive a rate determined by the measuring unit for the load of the conveyor belt. Furthermore, the control unit can comprise a memory unit, in which a set point value for the load rate of the conveyor belt can preferably be stored. Such a set point value can be entered or set by an operator, for example and/or be sent to the control unit, for example by the belt drive or another apparatus. It is particularly preferred, when a set point value is derived and used from values for the load rate of the conveyor belt that have previously been determined in this (or another) conveyor and have preferably been saved and possibly further processed.

The control unit particularly serves the purpose of comparing the current value of the conveyor load rate determined by the measuring unit with a set point value, which is preferably predetermined. The set point value is preferably selected in such a way that it corresponds to such a load of the conveyor belt with animal products, at which the belt drive can still drive the conveyor belt in at least one direction, that is at which an overload of the conveyor belt has not yet occurred. When the current value for the load rate of the conveyor belt, determined by the measuring unit, now approaches the set point value and a (preferably predetermined) distance to the set point value is exceeded or under-run, the control unit generates and preferably also displays a warning message. In particular, it is preferred that such a warning message is generated, when a predetermined distance between the determined load rate of the conveyor belt and the set point value is under-run, which means that the current value moves too close to the set point value. Such an approach of the current value to the set point value indicates an imminent overload situation. By generating and preferably displaying a warning message, for example an acoustical and/or optical and/or other warning signal, which can be sent to a mobile terminal device or a computer, for example, a farmer can be enabled to intervene, in order to prevent the imminent overload situation.

It is particularly preferred that a signaling device is present for issuing the warning signal. The warning signal can be issued in the sense of a traffic light display, in order to show different stages of imminent overload. This is particularly advantageous, when such a warning message, in particular in the form of a traffic light, can be shown to the workers in charge of loading the conveyor belt, so that they can adjust the load speed or the load amount accordingly. For example in broiler fattening, this can be realized for example in the form that the workers in charge of opening the bottoms of the livestock structures, load more or fewer broilers depending on the warning message, preferably in the form of a traffic light, to the belt, in order to achieve a more or less even stream of animal products on the conveyor belt without overload.

In another embodiment, it is preferred that the measuring unit is designed to repeatedly determine the load rate of the conveyor belt, for example in regular intervals and/or event-driven and/or user-driven.

This design has the intention that the measuring unit does not only determine the load of the conveyor belt one time, but multiple times. It is particularly preferred that the determination is carried out in regular intervals, preferably automatically. For example, an automatic, regular determination of a value for the load rate of a conveyor belt can be carried out by the measuring unit in an interval of seconds, minutes, hours and/or days. Preferably, the interval can be specified by an operator. In addition, or alternatively, the determination of a load rate of the conveyor belt can occur driven by events, which means, for example, always after the startup of the conveyor belt, before and/or after a purgation process and/or when other events occur. Another additional or alternative possibility is that an operator can initiate the determination of a preferably current value of the load rate of the conveyor belt by the measuring unit.

With such a repeated determination of the load rate of the conveyor belt, a preferably chronological development of the load rate can be derived in the control unit.

The control unit is furthermore preferably designed to compare the determined load rate of the conveyor belt with a maximum load value and to display a difference value determined by this comparison.

The maximum load value can, for example, correspond to the set point value, which is preferably predetermined. If the current value for the load rate of the conveyor belt is lower than the maximum load value, then the difference value corresponds to an additional maximum possible load. If the current value of the load rate of the conveyor belt is larger than the maximum load value, then the difference value shows the rate for the overload of the conveyor belt.

Further advantages particularly arise, when the control unit is designed to calculate a maximum additional load period from the difference value and a load value per time; and/or to calculate a maximum load value per time from the difference value and an additional load period.

In particular, if the difference value corresponds to the maximum possible additional load, i.e. if the calculated rate for the load of the conveyor belt is lower than the maximum load value, then this difference value can be used, in order to calculate, for how much longer the conveyor belt can be loaded at a certain load rate, before an overload occurs and/or with which load rate the conveyor belt can still be loaded for a predetermined time period, in order to also prevent overload. Here, it is also advantageous that the respective results can be issued and displayed in order to make it possible for an operator and/or co-workers to take certain coordinated measures.

Here, it is furthermore particularly preferred that the control unit is designed to save the calculated rate in the course of time and to preferably derive an average load rate of the conveyor belt per time unit, preferably in a certain time frame.

This design has the advantage that data on the change of the load rate of the conveyor belt can be saved and load rates, i.e. a load of the conveyor belt per time unit, can be derived, for example, for different time periods and different surrounding conditions. If these surrounding conditions can additionally be saved, then this data can also be used for the prognosis of future load rates under similar conditions.

If a known, determined and/or forecast anticipated additional load of animal products exceeds a previously calculated or predetermined maximum load, a warning signal is preferably generated. As described above, this warning signal can be an optical or acoustical signal or a combination of signals.

A design of the conveyor is particularly preferred in which the load rate of a conveyor belt is at least one of the following group: a power value of the belt drive, in particular a current consumption and/or the torque of the belt drive; a stretching deformation of an element of the conveyor; a force impacting on an element of the conveyor, in particular pressure and/or traction; a bearing reaction of a bearing in the belt drive; the weight of animal products located on a section of the conveyor belt; a deviation, in particular in vertical direction, a bearing of a section of the conveyor belt from an initial position; a conveyor belt progress, in particular a conveyor belt speed.

It is furthermore particularly preferred that the measuring unit is designed as a force sensor, in particular a pressure sensor and/or traction sensor, such as a load cell and/or strain gauge; a torque sensor, such as a strain gauge; a current measuring device; a distance sensor; and/or a conveyor belt progress detector, in particular a speed monitor and/or measuring wheel.

In particular, combinations of measuring units and a load rate of the conveyor belt are preferred that have a respective clearance in the way that the measuring unit can calculate the respective load rate of the conveyor belt. In the following, some particularly preferred combinations of the load rate of the conveyor belt and measuring unit are listed along with their arrangement, where applicable.

A preferred embodiment of a conveyor is designed in the way that the load rate of the conveyor belt is a current consumption of the belt drive; and the measuring unit is a current measuring device that is preferably designed and arranged in the way that it calculates a current of a conductor of the belt drive.

Here, it is particularly preferred to combine the measurement of the current consumption with a conveyor belt progress detector, e.g. a speed monitor, for example on a return pulley or a separate measuring wheel on the conveyor belt. Such a conveyor belt progress detector can be used as a control instrument to detect whether slack occurs. Beginning slack indicates that the determined current consumption is no longer a direct measurement for the drive power impacting on the conveyor belt, but that a, possibly low, overload has already occurred. In the extreme case, no conveyor belt movement occurs despite high current consumption with complete slack slippage. It is not only particularly preferred to determine whether slack occurs, but also to which extent, which can be used as an indicator for the intensity of the overload.

Another preferred embodiment of a conveyor has the intention that the load rate of the conveyor belt is the torque of the belt drive; and the measuring unit comprises at least one strain gauge, which is preferably mounted to the axle journal of the belt drive.

Another preferred embodiment of a conveyor has the intention that the load rate of the conveyor belt is a bearing reaction of a bearing in the belt drive; and the measuring unit comprises at least one force sensor, which is preferably mounted to the drive roll of the belt drive.

Another preferred embodiment of a conveyor has the intention that the load rate for the conveyor belt is a deviation in the vertical direction of a position of a section of the conveyor belt between two conveyor belt carriers from an initial position; and the measurement unit comprises at least one distance sensor, which is preferably arranged in the vertical direction underneath the conveyor belt between to conveyor belt carriers.

Another preferred embodiment of a conveyor has the intention that the load rate of the conveyor belt is the weight of the animal products located on a section of the conveyor belt; and the measuring unit comprises at least one load cell, which is arranged on a conveyor belt carrier, in particular a conveyor belt bottom joist and/or conveyor lateral support.

Another preferred embodiment of a conveyor comprises a correction device that is designed and arranged to change the orientation of a belt drive depending on a correction signal; wherein the load rate of the conveyor belt is a traction force impacting on a correction device; and the measuring unit comprises at least one strain gauge for the determination of the traction force impacting on the correction device and preferably one conveyor belt progress detector.

According to another aspect, the initially mentioned task is solved through a drive unit for a conveyor for conveying animal products in an agricultural business, in particular for a previously described conveyor, comprising a belt drive for driving the conveyor belt in a minimum of one conveying direction, a measuring unit that is designed and arranged to determine a load rate of the conveyor belt, wherein the load rate of the conveyor belt is a power value of the belt drive and/or a bearing reaction of a bearing in the belt drive.

Particularly preferable embodiments of the drive units are listed in the following.

A preferred embodiment of a drive unit comprises a control unit designed to compare the determined load rate of the conveyor belt with a set point value and preferably to generate a warning message, when a predetermined deviation from the set point value is exceeded or under-run.

Another preferred embodiment of a drive unit has the intention that the measuring unit is designed to repeatedly determine the load rate of the conveyor belt, for example in regular intervals and/or event-driven and/or user-driven.

Another preferred embodiment of a drive unit provides for the control unit being designed to compare the determined load rate of the conveyor belt with a maximum load value and to display a difference value determined by this comparison.

Another preferred embodiment of a drive unit provides for the control unit being designed to calculate a maximum additional load period from the difference value and a load value per time; and/or to calculate a maximum load value per time from the difference value and an additional load period.

Another preferred embodiment of a drive unit provides for the control unit being designed to save the calculated rate in the course of time and to preferably derive an average load rate of the conveyor belt per time unit, preferably in a certain time frame.

Another preferred embodiment of a drive unit is designed in the way that the load rate of the conveyor belt is a current consumption of the belt drive; and the measuring unit is a current measuring device that is preferably designed and arranged in the way that it calculates a current of a conductor of the belt drive.

Another preferred embodiment of a drive unit provides for the load rate of the conveyor belt being the torque of the belt drive; and the measuring unit comprising at least one strain gauge, which is preferably mounted to the axle journal of the belt drive.

Another preferred embodiment of a drive unit provides for the load rate of the conveyor belt being a bearing reaction of a bearing in the belt drive; and the measuring unit comprising at least one force sensor, which is preferably mounted to the drive roll of the belt drive.

Another preferred embodiment of a drive unit comprises a correction device that is designed and arranged to change the orientation of a belt drive depending on a correction signal; wherein the load rate of the conveyor belt is a traction force impacting on a correction device; and the measuring unit comprises at least one strain gauge for the determination of the traction force impacting on the correction device and preferably one conveyor belt progress detector.

In regard to the advantages, versions of embodiments and embodiment details of the drive unit and their further embodiments, reference is made to the above description in regard to the corresponding features of the conveyor.

According to another aspect, the initially mentioned task is solved through a method for conveying animal products in an agricultural business, in particular for a previously described conveyor, comprising a belt drive for driving the conveyor belt in a minimum of one conveying direction, a measuring unit that is designed and arranged to determine a load rate of the conveyor belt, wherein the load rate of the conveyor belt is a power value of the belt drive and/or a bearing reaction of a bearing in the belt drive.

The method according to the invention can preferably be further developed wherein the determined load rate of the conveyor belt is compared to a set point value and preferably a warning message is generated, when a predetermined deviation from the set point value is exceeded or under-run. Further, the load rate of the conveyor belt may be repeatedly determined, for example in regular intervals and/or event-driven and/or user-driven. The method may further include the steps of comparing the determined load rate of the conveyor belt with a maximum load value and issuing a difference value determined by the comparison. Additionally, the method may include the steps of determining a maximum additional load period from the difference value and a load value per time; and/or determining a maximum load value per time from the difference value and an additional load period. Finally, the method may include the step of saving the determined load rate of the conveyor belt over the course of time, and preferably deriving an average load rate of the conveyor belt per time unit, preferably in a certain time frame.

Further advantageous embodiments of the method arise, when the load rate of a conveyor belt is determined with at least one of the following group: a power value of the belt drive, in particular a current consumption and/or the torque of the belt drive; a stretching deformation of an element of the conveyor; a force impacting on an element of the conveyor, in particular pressure and/or traction; a bearing reaction of a bearing in the belt drive; the weight of animal products located on a section of the conveyor belt; a deviation, in particular in vertical direction, a bearing of a section of the conveyor belt from an initial position; a conveyor belt progress, in particular a conveyor belt speed.

Further advantageous embodiments of the method in particular also result from the fact that for the calculation of the load rate of the conveyor belt, a measuring unit is used, which is designed as a force sensor, in particular a pressure sensor and/or traction sensor, such as a load cell and/or strain gauge; a torque sensor, such as a strain gauge; a current measuring device; a distance sensor; and/or a conveyor belt progress detector, in particular a speed monitor and/or measuring wheel.

In regard to the advantages, versions of embodiments and embodiment details of this method and their further embodiments, reference is made in the meantime to the above description in regard to the corresponding features of the conveyor.

Preferred embodiments of the invention are described as examples based on the attached figures. The following is shown in:

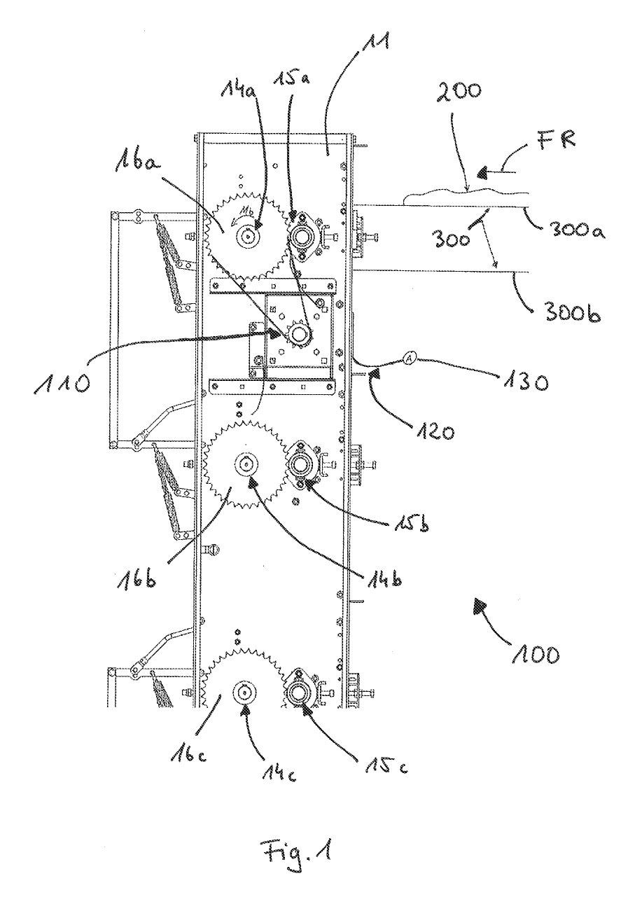

FIG. 1 is a partial view of a first further exemplary embodiment of a conveyor according to the invention;

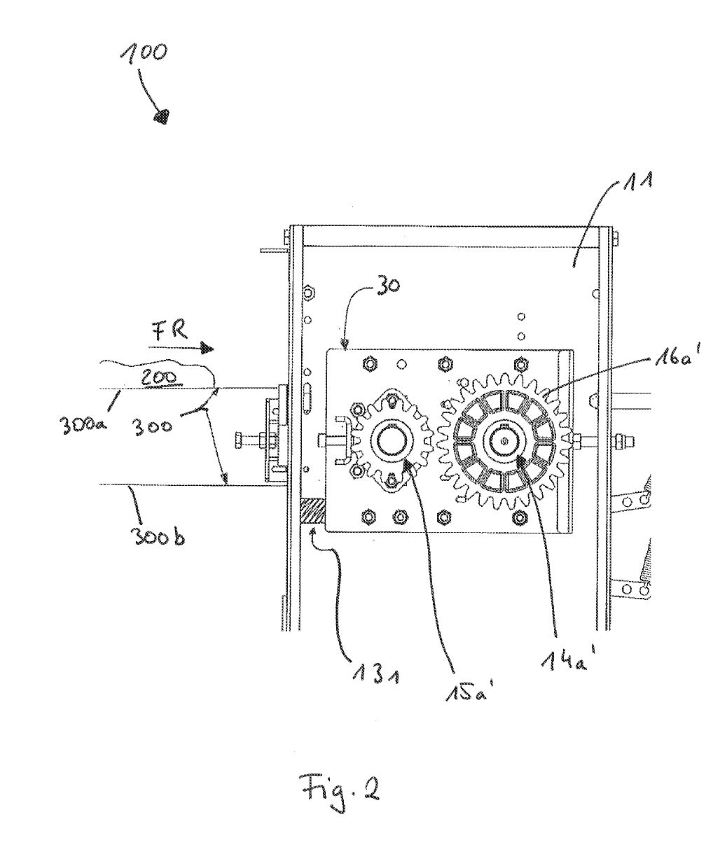

FIG. 2 is a partial view of a second further exemplary embodiment of a conveyor according to the invention;

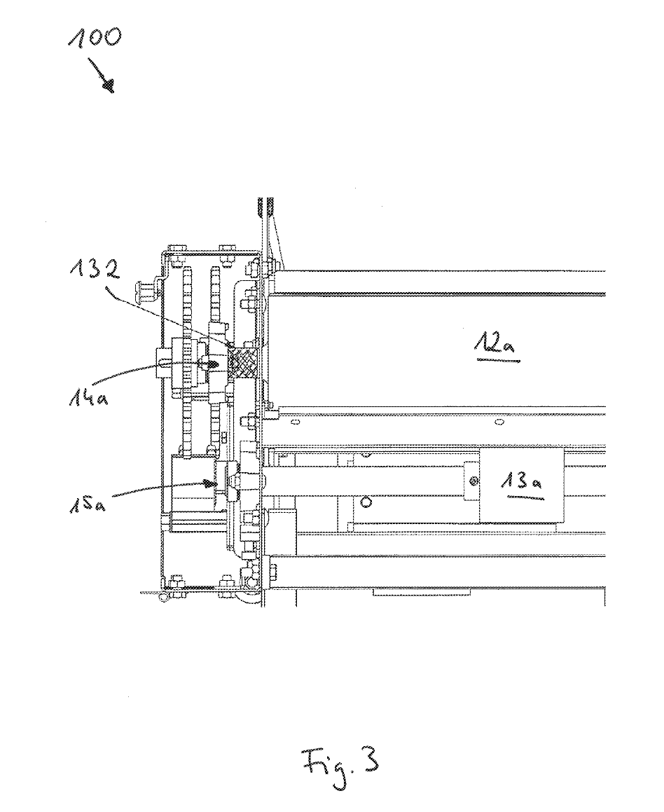

FIG. 3 is a partial view of a third further exemplary embodiment of a conveyor according to the invention;

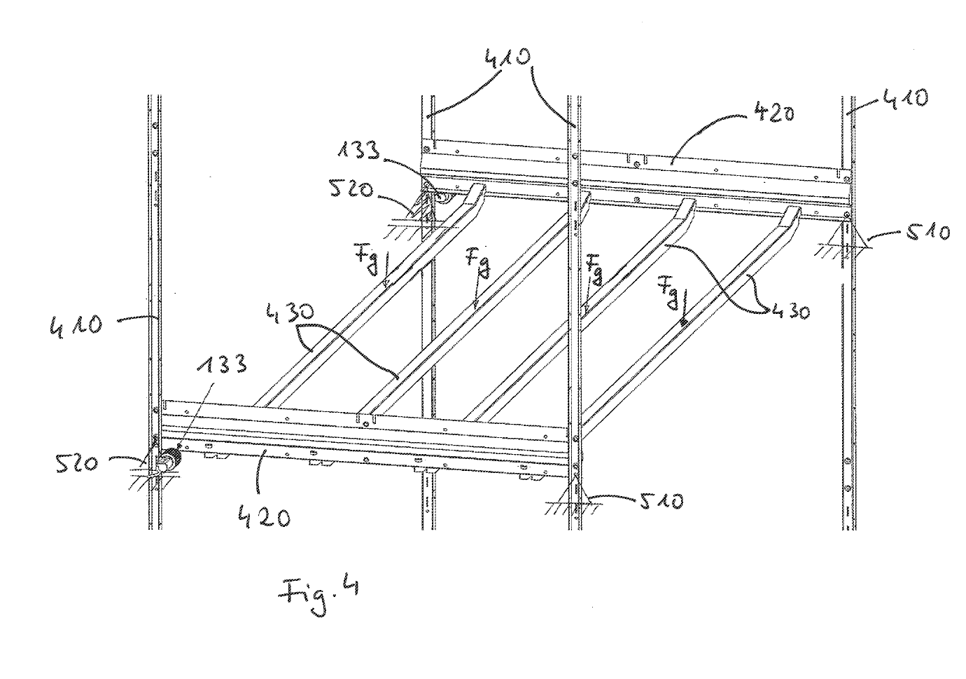

FIG. 4 is a three-dimensional view of a support structure of another exemplary embodiment of a conveyor according to the invention;

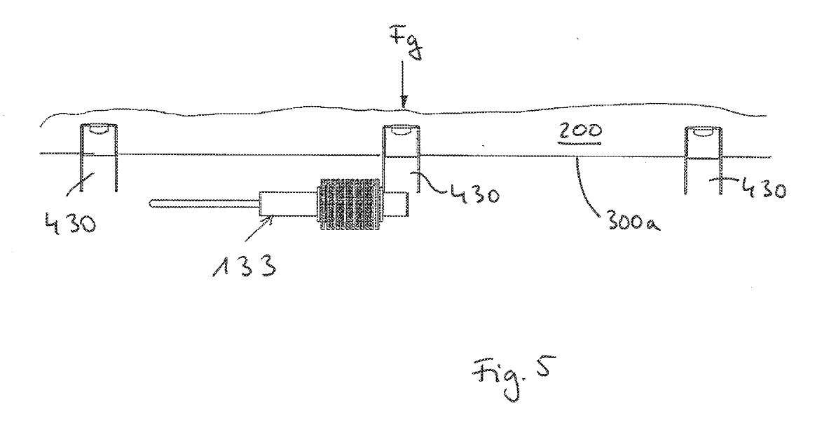

FIG. 5 is a partial cross-section of a variation of the embodiment shown in FIG. 4; and

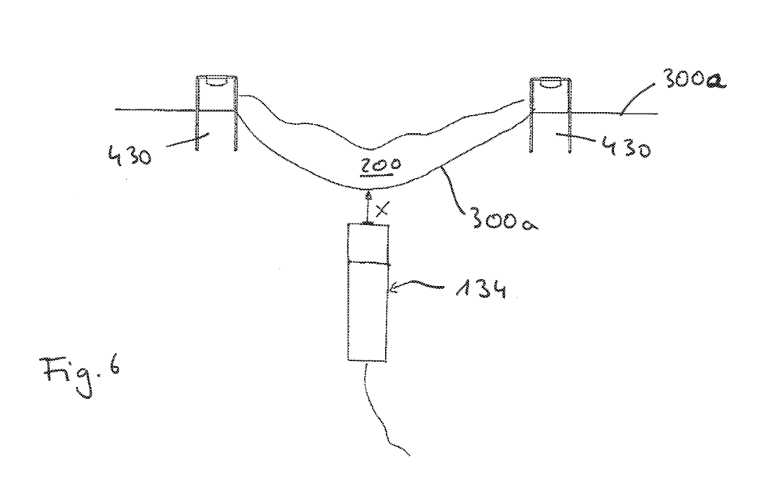

FIG. 6 is a partial cross-section of a further exemplary embodiment of a conveyor according to the invention.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

FIGS. 1 to 6 show different further exemplary embodiments of a conveyor according to the invention. Equal or essentially equal elements or respectively elements with equal or respectively essentially equal functions are described in the different figures with equal reference signs, partially with a following “′”.

In FIG. 1, a partial view of a first further exemplary embodiment of a conveyor 100 according to the invention is shown. A drive frame 11 can be seen, with three bearings 14a, 14b, 14c arranged on top of each other in vertical direction, for the bearing of three equally vertically on top of each other arranged belt drives, which serve the purpose of driving three equally vertically on top of each other arranged conveyor belts. On bearings 15a, 15b, 15c, pressure rolls are located, which press the conveyor belt of the respective level to the respective drive roll, in order to transfer the drive power to the conveyor belt. In FIG. 1, only the top one of these three conveyor belts of the three-level design conveyor 100 is shown.

The conveyor belt 300 is designed with an upper run 300a and a lower run 300b. The upper run 300a is loaded with animal products, here feces 200, while the conveyor belt 300 is driven by the belt drive in the way that the feces can be moved in one conveying direction FR. The conveyor belt 300 is pressed to the drive roll by pressure rolls that are supported at the bearing 15a, in order to be driven by the friction, which is thus created in the conveying direction FR.

The bearing 14a is connected to a sprocket 16a, which can be driven by a motor via a chain and thus torque M_{b} is transferred to the belt drive, which then drives the conveyor belt 300 in the conveying direction FR.

As the load rate of the conveyor belt 300 with animal production, here feces 200, a motor current monitoring is used in the embodiment according to FIG. 1. That is, the recorded current of the drive motors 110 is determined in the conductor 120 with a current measuring device 130. From this recorded motor current, the torque M_{b} can be determined, which is needed in order to move the conveyor belt 300. With the increasing load of the conveyor belt 300, the torque M_{b} necessary for the drive of the conveyor belt 300 increases together with the recorded motor current. If the characteristic of the drive motor 110 is known, then the difference to a maximum torque can be calculated from the necessary torque currently recorded from the motor current, and from this difference, a maximum possible additional load can be calculated, if applicable with a safety margin, with which the conveyor belt 300 can be additionally loaded, and simultaneously a reliable drive of the conveyor belt through the belt drive can be secured. If the maximum torque is exceeded, a standstill of the conveyor belt 300 with the corresponding disadvantages can occur.

Preferably, a warning message is issued if the currently necessary torque, which can be calculated from the currently recorded motor current, falls below a predetermined distance from the maximum torque, so that the animal products 200 located on the conveyor belt 300 can be removed before an overload of the conveyor belt 300 occurs.

In particular, it is preferred to combine the measurement of the current consumption in a current measuring device 130 with a conveyor belt progress detector, for example, a speed monitor on a return pulley or a separate measuring wheel on the conveyor belt 300, in order to ensure that slack is detected. Beginning slack indicates that the calculated current consumption is no longer a direct measurement for the drive power impacting on the conveyor belt, but a, possibly low, overload has already occurred.

A further possibility to determine the traction force of the conveyor belt consists for example in that one or multiple strain gauges are arranged between the bearing of a drive roll or the belt drive and the supporting lateral or drive frame 11 in order to directly determine the traction forces there.

Another possible embodiment of a conveyor according to the invention 100 is shown in FIG. 2. FIG. 2 shows an embodiment of a conveyor 100 similar to the one shown in applicant's utility model application DE 20 2012 010 170.6. The conveyor 100 described therein has an automatic conveyor belt control, which controls the fault-free straight running of the conveyor belts. Here, both the pressure rolls as well as the drive roll are arranged across an adjustment plate 30 so that they can move horizontally in and opposite to the conveying direction FR via the bearings 15a′ and 14a′. The adjustment plate 30 is preferably connected to a servo motor or respectively a correcting device, in order to be able to shift the adjustment plate 30 horizontally with the bearings 14a′, 15a′.

According to the embodiment of FIG. 2, a bearing reaction of the bearing 14a′ of the belt drive can be used as the load rate of the conveyor belt, wherein the corresponding measuring unit 131 is preferably designed as a force sensor arranged at a bearing 14a′ of a drive roll of the belt drive, specifically indirectly above the adjustment plate 30 in FIG. 2. Since there is a side or a drive frame 11 on both sides of the conveyor with each one adjustment plate 30 and respective bearings 14a′, 15a′ for the drive roll and the pressure rolls, each one force can be determined in the respective force sensors 131, which corresponds to half of the traction force F_{z} of the conveyor belt 300. The resulting traction force of the conveyor belt 300 therefore occurs, divided by the factor of 2, at the bearings 14a′ of the drive roll of the belt drive and can be recorded via the force sensors 131. In a control unit (not shown), the values determined by the force sensors 131 can be evaluated in order to facilitate a conclusion regarding the load of the conveyor belt 300 with animal products.

Alternatively, the traction forces to be determined can also be recorded via a strain gauge at the servo motor of the adjustment plate 30. Here, the connection with a conveyor belt progress detector is also preferred. In this way, the currently working traction forces can be determined in a reliable way and processed in a control unit, in order to determine a load rate of the conveyor belt and thus realize the advantages described above.

In FIG. 3, another possible embodiment of a conveyor 100 according to the invention is shown. In the partial view of FIG. 3, the drive roll 12a supported at the bearing 14a as well as a drive roll 13a supported at the bearing 15a can be seen. In the variation shown in FIG. 3, a torque is used as a load rate of the conveyor belt, wherein the measuring unit is designed as a strain gauge 132, which is arranged at an axle journal of the drive roll 12a of the belt drive.

In this variation, the evaluation possibilities mentioned above can also be connected to the equally previously mentioned advantages.

In FIGS. 4 and 5, variations are shown in which a weight of the animal products located on a section of the conveyor belt is used for the load rate of the conveyor belt. Here, the measuring unit is designed to be a load cell 133. In FIG. 4, two conveyor belt side supports 420 are mounted to vertical stands 410 via fixed bearings 510 and respectively via movable bearings 520. At the conveyor belt side supports 420 in turn, conveyor belt bottom joists 430 are mounted, on which the conveyor belt (not shown in FIG. 4) runs. The weight force of the animal products F_{g} to be transported on the upper run of the conveyor belt impacts on the conveyor belt bottom joists 430. Via the mounting of the conveyor belt bottom joist 430 on the conveyor belt side supports 420, this weight force F_{g} is transferred to the movable bearings 520, at which each one load cell 133 is arranged, which can record the respective weight forces.

In the variation shown in FIG. 5, one or preferably two load cells 133 are arranged under at least one of the bottom joists 430, which can directly record the weight force F_{g} there.

Here, after recording the weight as the load rate of the conveyor belt, another evaluation and processing follows as well, preferably in a not-shown control unit in the way described above with the also described advantages.

In FIG. 6, another variation is shown, in which a deviation in vertical direction from a position of a section of the conveyor belt 300, in particular of the upper run 300a, between two conveyor belt carriers, here conveyor belt bottom joists 430, from an initial position is used for the load rate of the conveyor belt. The measuring unit is embodied in the variation shown in FIG. 6 as a distance sensor 134, which is arranged in the vertical direction beneath the lower run 300a of the conveyor belt between two conveyor belt carriers, here conveyor belt bottom joists 430. The initial position of the lower run 300a of the conveyor belt can be seen in FIG. 6 on the right and left side of the conveyor belt bottom joists 430. The distance sensor 134, however, measures between the two conveyor belt bottom joists 430 only a distance X to the lower run 300a of the conveyor belt in the middle between the two conveyor belt bottom joists 430. Compared to the initial position of the upper run 300a of the conveyor belt, to be seen on the right and left side of the conveyor belt bottom joists 430, there is therefore a deviation between the bottom joists 430 in vertical direction of the position of the section of the conveyor belt from this initial position. This deviation can also be described as sagging. With increasing load of the conveyor belt with animal products 200, this sagging increases, which means that the distance X measured by the distance sensor 134 to the upper run 300a of the conveyor belt decreases.

After the determination of the load rate of the conveyor belt, the position deviation, the described evaluation and further processing steps can follow, such as issuing warning messages and/or calculations of further possible maximum loads, load rates and/or load times, in this variation as well. By way of these evaluations and further processing steps, measures can be facilitated for a farmer or operators of agricultural businesses and the employees that work there that can counteract and prevent an overload of a conveyor belt at an early point in time. In this way, disadvantageous situations with loaded, but no longer conveying-capable conveyor belts can be avoided and/or reduced.

It is to be understood that variations and modifications can be made on the aforementioned structure without departing from the concepts of the present invention, and further it is to be understood that such concepts are intended to be covered by the following claims unless these claims by their language expressly state otherwise.

1-15. (canceled)

16. A conveyor to convey animal products in an agricultural business comprising:
a conveyor belt,
a belt drive to drive the conveyor belt in at least one conveying direction, and
a measuring unit for determining a load rate of the conveyor belt,
wherein the load rate of the conveyor belt is determined by any or all of a power value of the belt drive or a bearing reaction of a bearing in the belt drive.

17. The conveyor according to claim 16, comprising a control unit, which compares the determined load rate of the conveyor belt with a set point value and generate a warning message if a predetermined deviation is above or below the set point value.

18. The conveyor according to claim 16, wherein the measuring unit repeatedly determines the load rate of the conveyor belt in any or all of regular intervals, event-driven intervals, or user-driven intervals.

19. The conveyor according to claim 17, wherein the control unit compares the determined load rate of the conveyor belt with a maximum load value and displays a difference value determined by this comparison.

20. The conveyor according to claim 19, wherein the measuring unit determines a maximum additional load period from the difference value and a load value per time, and the measuring unit determines a maximum load value per time from the difference value and an additional load period.

21. The conveyor according to claim 17, wherein the control unit saves the calculated rate in the course of time and derives an average load rate of the conveyor belt per time unit.

22. The conveyor according to claim 22, wherein the control unit derives an average load rate in a certain time frame.

23. The conveyor according to claim 16, wherein the load rate of the conveyor belt is at least one out of the following group:
a current consumption or torque of the belt drive;
a stretching deformation of an element of the conveyor;
a force impacting on an element of the conveyor, the force being any or all of a particular pressure or traction force;
a weight of the animal products located on a section of the conveyor belt;
a deviation in the vertical direction of a position of a section of the conveyor belt from an initial position; and
a conveyor belt progress.

24. The conveyor according to claim 23, wherein the conveyor belt progress is a conveyor belt speed.

25. The conveyor according to claim 16, wherein the measuring unit is designed as a force sensor, the force sensor being any or all of a pressure sensor, traction sensor, load cell, strain gauge, torque sensor, current measuring device, distance sensor, or a conveyor belt progress detector, the conveyor belt progress detector being any or all of a speed monitor or measurement wheel.

26. A drive unit for a conveyor to convey animal products in an agricultural business, the drive unit comprising:
a belt drive to drive the conveyor belt in at least one conveying direction, and
a measuring unit to determine a load rate of the conveyor belt,
wherein the load rate of the conveyor belt is any or all of a power value of the belt drive or a bearing reaction of a bearing in the belt drive.

27. A method for conveying animal products in an agricultural business with a conveyor, the method comprising the steps of:
driving a conveyor belt with a belt drive in at least one conveying direction, and
determining a load rate of the conveyor belt using a measuring unit,
wherein the load rate of the conveyor belt is any or all of a power value of the belt drive or a bearing reaction of a bearing in the belt drive.

28. The method according to claim 27, wherein the determined load rate of the conveyor belt is compared to a set point value and a warning message is generated when a predetermined deviation is above or below the set point value.

29. The method according to claim 27, wherein the load rate of the conveyor belt is repeatedly determined in any or all of regular intervals, event-driven intervals, or user-driven intervals.

30. The method according to claim 27, including the steps of:
comparing the determined load rate of the conveyor belt to a maximum load value; and
issuing a difference value determined by the comparison.

31. The method according to claim 30, including the step of determining a maximum additional load period from the difference value and a load value per time.

32. The method according to claim 30, including the step of determining a maximum load value per time from the difference value and an additional load period.

33. The method according to claim 27, including the step of saving the determined load rate of the conveyor belt over the course of time.

34. The method according to claim 27, including the step of deriving an average load rate of the conveyor belt per time unit.

35. The method according to claim 34, wherein the average load rate of the conveyor belt per time unit is derived within a certain time frame.
